(19) United States
(12) Patent Application Publication
(10) Pub. No.: US 2007/0118445 A1
(43) Pub. Date: May 24, 2007

(54) System and method for investment accounting and auditing

(76) Inventor: Bruce Hechler, Edgewater, MD (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/603,657

(22) Filed: Nov. 22, 2006

Related U.S. Application Data
(60) Provisional application No. 60/739,801, filed on Nov. 23, 2005.

(51) Int. Cl. G07F 19/00; G07B 17/00

(52) U.S. Cl. 705/30

(57) ABSTRACT

A system and method allows a user to accurately track and account for investments, as well as determine and present financial and tax consequences of financial and realizable events related to such investments. The system receives identifying data for a security, which includes at least data regarding a tax lot method. The system correlates a financial event, which can be an income event, capital change event, or a combination thereof, to the security. The system then determines a tax consequence based on the financial event and the identifying data. Finally, the system presents a complete security audit report comprising the tax consequence, a transaction ledger, a security financial position, an IRS-compliant Schedule “D,” an IRS-compliant Schedule “B” and the tax opinion. Multiple databases can be utilized including but not limited to a tax opinion database, capital change event database and income event database, among others. Further, the databases can be remotely located from one another.

### CROSS-REFERENCE TO RELATED APPLICATIONS

The present application claim the benefit of U.S. Provisional Patent Application Ser. No. 60/739,801, filed Nov. 23, 2005, the entirety of which is hereby incorporated by reference.

### FIELD OF INVENTION

The invention relates generally to the field of accounting and auditing systems, and specifically to a system and method for accurately tracking and accounting for investments, as well as determining and presenting financial and tax consequences of realizable events related thereto.

### BACKGROUND OF THE INVENTION

Managing a portfolio of investment securities presents a number of accounting challenges. This can be especially true if a portfolio of investment securities comprises a variety of securities such as stocks, bonds, options and the like. One challenge is assuring that all income and position changes in investment securities that are reported by a custodian, such as a public accounting firm, are correct. As there are many types of investment securities, the income and position changes, among others, may be difficult to correctly report. Such income and position changes can be numerous and may include changes concerning mutual fund reinvesting dividends, stock conversion, sale of a portion of stock, stock-splits, spin-offs and mergers, among others. The process can be complex and involves finding and researching all relevant events for a security, interpreting the tax and share implications of each transaction and finally computing the financial effects of each. When this process must be performed for entire portfolio of securities, it can be a time-consuming process that could result in accounting errors, particularly in the determination of gain or loss associated with one or more securities in the portfolio.

Further, the tax effects (e.g., gain and loss, return of capital, earned income) can be a very difficult task for a custodian or auditor to verify. The auditor must, in many instances, specifically keep track of each of the securities in order to track the tax liability of individual securities.

It is also difficult to verify the tax liability and assure that all cost basis changes due to capital change transactions are correctly applied to the portfolio of securities. Many owners of securities portfolios (e.g., individuals as well as business entities) utilize the services of tax professionals to prepare and complete the tax returns associated with a portfolio of securities. In order to prepare a tax return, the individual or entity in most instances manually enters the accounting records data or enters the accounting data records in-house. Many business, however, do not employ in-house accountants that are capable of performing such function. As another alternative, the individual or entity can pay someone to generate that data for them. Typically, an owner of a portfolio of securities can expect to wait for a substantial amount of time in order for a tax professional to complete the tax returns. However, during this period of time the owner of the portfolio of securities is without exact knowledge as to the tax consequence. It is only after (or around the same time) the tax return is completed can the owner of the portfolio of securities discover or determine its tax consequence.

Without a real time understanding of its tax burden and liability an owner of a portfolio of securities is hindered in effectively planning for future tax burden and liability because the owner is not currently aware (in real time or near real time) of the financial decisions that could adjust the tax burden and liability that may become due. For example as a tax year nears its end, it can be very advantageous to capture long/short term capital gains to offset earlier (and opposite) gains and losses. This can only work if the investor knows the current tax situation.

While there have been attempts to solve these problems, such attempts have obvious drawbacks. Tax programs such as Quicken® or TurboTax® are used to estimate the taxes due after accounting data is manually entered into the tax program. The estimated taxes due, however, are presented only after the accounting data is compiled, logged and entered into the tax program. As important, these programs are limited by what a user inputs. As a consequence, these programs are often difficult to use and require specialized knowledge to verify the accuracy of the conclusions, number and other information presented.

Finally, there is the challenge of optimizing the tax consequence of a portfolio of investment securities. The Internal Revenue System (“IRS”) code allows for multiple methods of applying transactions of certain taxable types. Depending on the situation, the proper application of a particular accounting method to a particular transaction can produce significant tax benefits. Typically, the default accounting method of first-in, first out (“FIFO”) is used for determining taxable gain or loss. For mutual funds the default accounting method is the average basis in the mutual fund shares held. In many instances, however, the default accounting method is the least desirable accounting method to employ. Other tax accounting methods that may be more desirable can include last-in, first-out (“LIFO”). Thus, it is desirable for tax optimization to be performed accurately and in accordance with all applicable laws, a task that is both time consuming and could have costly ramifications if done incorrectly.

The IRS also occasionally perform audits of the filed personal and business returns to ensure compliance with applicable tax laws. During an audit, individuals and business entities are required to produce detailed financial records, which may include detailed financial information and supporting documentation. The financial records possibly required to be disclosed may span over a few or several years. Many times, however, the amount of resources and time needed to be devoted to these audits are substantial. Thus, faced with an IRS audit, compliance with such an audit are often times overwhelming to individual or business entity being audited.

Consequently, one of the disadvantages of the above-referenced systems is that there is no way to address and correctly solve these drawbacks as often times financial information, documents and the like must be compiled and presented to an auditor. There is an obvious need to present such audit documents in an organized format. Moreover, central databases are generally not available for all required or necessary data. Thus, there is a need in the art to address the drawbacks and disadvantages as described herein.

Accordingly, the current invention provides for a system and method for accurately tracking and accounting for investments, as well as determining financial and tax consequences of realizable events related thereto.

### SUMMARY OF THE INVENTION

It is therefore an object of the present invention to provide a system and method for accurately tracking and accounting for investments.

It is also an object of the present invention to provide a system and method for presenting a security audit report for a security or a portfolio of securities.

These and other objects are met by the present invention, which in one aspect is a method of auditing and verifying the tax liability of a security and providing a security audit report, wherein the method includes (i) receiving identifying data for a security, where the identifying data contains at least a tax lot method, (ii) correlating a financial event to the security, (iii) determining a share effect based on the financial event and the identifying data, (iv) determining a cost basis effect based on the financial event and the identifying data, (v) determining a tax consequence based on the financial event and the identifying data, (vi) retrieving a tax opinion that is based on the tax consequence; and (vii) presenting a security audit report comprising the tax consequence, a transaction ledger, a security financial position and the tax opinion. The security audit report can also include an IRS Schedule “D” corresponding and an IRS Schedule “B,” which should both be based on the tax consequence. In addition, the tax opinion should preferably be compliant with IRS standards. In one embodiment, the method further includes correlating a taxation status to the financial event. The tax consequence in the embodiment is likewise further based on the taxation status, and the security audit report additionally includes the taxation status.

The security can include but is not limited to a stock, a preferred stock, a bond, a convertible stock, an open-ended mutual fund, a closed end mutual fund, a corporate bond, a municipal bond, a government backed mortgage, a collateralized mortgage security, a non-U.S. based security, a U.S. Treasury security, an option or a warrant. In one preferred embodiment, the security is a plurality of securities or a portfolio of securities. In this embodiment, the plurality of securities can include, but is not limited to, any combination of the aforementioned types of securities. The identifying data can include but is not limited to security identification number (e.g., CUSIP), a desired type of transaction, a transaction date, a beginning date, an ending date, a share position and a share price.

The financial event is contained in a financial events database and the tax opinion is contained in a tax opinion database, the tax opinion database being remotely located from the financial events database. The financial event, tax opinion, and taxation status can be contained in one or several databases. In one embodiment, the financial event is located in a separate financial events database and the tax opinion is located in a tax opinion database. In such an embodiment, the tax opinion database is located at a remote location from that of the financial events database. The tax opinion database can be housed remotely on any of a number of commercially available databases. In another embodiment, the taxation status is contained in a taxation status database, preferably remotely located from the financial events database.

In yet another embodiment, the financial event can be either an income event or a capital change event, both an income event and a capital change event, or any combination thereof. In a preferred embodiment, the financial event comprises an income event and a capital change event. In such as preferred embodiment, the income event is contained in an income event database and the capital event is contained in a separate capital event database. The capital event can be selected from (but is not limited to) a merger, a conversion, an exchange, a merger election, a spin-off, a distribution, a recapitalization, a liquidation, a partial bond call, a stock split and a stock dividend. In one embodiment, the method of the present invention further includes the step of receiving merger election data, which means that the capital change event is the merger election.

In yet another aspect, the present invention is a method of auditing and verifying tax liability of a security and providing a security audit report including the steps of receiving identifying data for a security, the identifying data contains at least a tax lot method; correlating a capital change event to the security; correlating an income event to the security; correlating a taxation status to the capital change event; determining a tax consequence based on the taxation status, the capital change event, the income event and the identifying data; retrieving a tax opinion corresponding to the tax consequence; and presenting a security audit report comprising the tax consequence, a transaction ledger, a security financial position, the taxation status and the tax opinion.

In one embodiment, the income event is contained in an income event database, the capital change event is contained in a capital change event database and the tax opinion is contained in a tax opinion database, the tax opinion database being remotely located from at least one of the capital change event database and the financial event database.

In a further aspect, the present invention is a system for auditing and verifying the tax liability of a security and providing a security audit report comprising a first database containing first data comprising at least one selected from the group consisting of an income event corresponding to the security, a capital change event corresponding to the security, and a taxation status corresponding to the security; a processor capable of receiving identifying data for a security, wherein the processor is capable of determining a tax consequence based on the first data; a second database containing a tax opinion; and a device capable of presenting a security audit report comprising the tax consequence, a transaction ledger based the first data, a security financial position and the tax opinion. The security audit can also include an IRS Schedule “D” corresponding to the corresponding to the tax consequence and an IRS Schedule “B” corresponding to the tax consequence. The first database can include an income event database containing an income event corresponding to the security and a capital change event database containing a capital change event corresponding to the security. The first database can also include a tax database containing a taxation status corresponding to the security.

### BRIEF DESCRIPTION OF THE DRAWINGS

FIG. 1 shows is a block diagram showing a method of auditing and verifying the tax liability of a security and providing a security audit report.

FIG. 2 is a block diagram showing an alternative embodiment of a system of the current invention.

FIG. 3 is a block diagram illustrating creation of the security audit report of the present invention.

FIG. 4 shows a graphic user interface for inputting information relating to a security or securities.

FIG. 5 is an exemplary database table of a “family-tree” of one or more securities.

FIG. 6 shows an exemplary merger election screen presented to a user by the system of the present invention.

FIG. 7 shows a first portion of a security audit report according to one aspect of the present invention.

FIG. 8 shows a second portion of a security audit report according to one aspect of the present invention.

### DETAILED DESCRIPTION OF THE INVENTION

The current invention provides for an improved accounting and auditing system, specifically, a system and method for accurately tracking and accounting investment securities, as well as determining financial and tax consequences of realizable events related thereto. More specifically, the current invention can provide for a security audit report detailing the accounting and other financial information relating to such investment securities.

The current invention includes improved accounting systems and methods to solve the disadvantages and drawbacks in the art. Specifically, the current invention addresses the drawbacks in the related art where the choices of tax lot relief methods (e.g., FIFO, LIFO, AVG, HICOST and LOWCOST, as explained in greater detail below) are not supported in the accounting methods, the overwhelming majority of which default to FIFO. The taxpayer or owner of the securities portfolio, however, may want to chose (or may have already chosen) a different tax lot method. As a result, the cost basis and resultant tax calculation can be incorrect if a user is limited to the default accounting method. For example, if a portfolio consists of 5 tax lots of the same security, each purchased on different dates at different prices, then a “sell” transaction of part of the total inventory can produce 5 different capital gains results depending on the tax lot relief method selected. Defaulting to FIFO (which is also the IRS default accounting method) may not produce the desired results or maximize the tax benefit to an owner of the securities portfolio.

The current invention also addresses special taxation statuses. Many mergers, spin-offs, exchanges and conversion transactions involving certain securities can be designated one of 5 possible tax statuses, which are generally unavailable using current methods and systems. These tax status types are: Non-Taxable, Capital Gains (consistent with Section 368 of the tax code), Gains/Loss, Ordinary Income (Dividend Income) and Return of Capital.

Significant errors may occur in calculating realized capital gains when assuming that all transactions are simply taxable. Such errors may result in an owner of a securities portfolio paying more taxes than the owner is required to pay. To aid in this process, the current invention also makes use of a number of recently developed data sources/databases and incorporates them into the current invention. Specifically, in one embodiment, a program or engine is capable of operably communicating with one or more databases. These databases, which in a preferred embodiment are external to the processor, can provide cost basis and capital changes, market or pricing data, and dividend data, among others. The program or engine after receiving the relevant data from the database in which it is in communication then normalizes such data through a data rationalization process, which converts the data in useable form by the processor. The processor can then use such converted data against the parameters inputted by a user of the system.

Finally, many mergers and exchanges have optional provisions, which involve selecting from a list of possible choices a specific path taken. The present invention contemplates the utilization of the increased availability of certain tax data correlating to transactions not previously available.

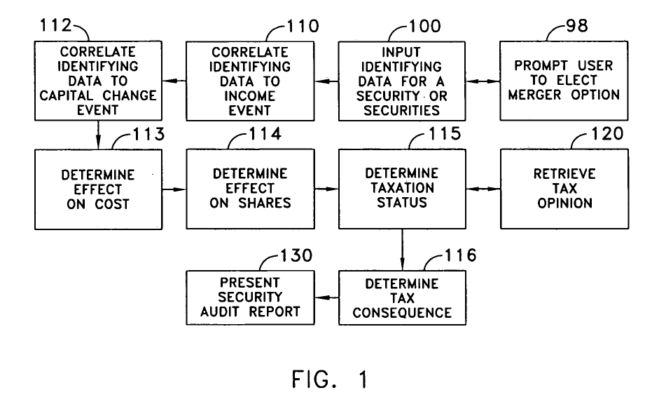

Referring to FIG. 1, a block diagram of one embodiment of the present invention is shown. The present invention receives from a user identifying data for a security in step 100. The identifying data can include (but is not limited to) any one of an identification number, which is in many instances a CUSIP number, the issuer of the security, the company the stock symbol, the date of acquisition, the date of sale, other fiscal year parameters, the number of securities purchased or acquired, trades of the securities made, and the preferred tax lot method, or Dividend Reinvestment selection. The identifying data can also be a combination of data including any combination of the identifying data just described. Optionally, the user can input the principal trades executed within a desired time period, which can include but is not limited to any buy or sell transactions during the time period.

In one particular embodiment, the current invention receives and stores beginning balances of investment securities on a prescribed starting date. In this embodiment, all principal transactions relating to a security or portfolio of securities from a prescribed starting date up to a prescribed end date are stored in a database. The use of this information can assist in determining (when used with other data or parameters) the effective income earned, cost basis adjustments and share positions, and other relevant data.

In yet another embodiment, the user can input whether the user wants any dividends to be reinvested. A dividend reinvestment event, for example with respect to mutual funds, is caused by the user designating a particular holding or security to be reinvested. Dividend data including but not limited to the dividend amount and the dividend reinvestment price can also be input or retrieved. If the reinvestment price cannot be obtained or ascertained, the closing price on the payment date of the security can be used. Alternatively, the engine can communicate with a pricing or market values database and obtain the current market value of the security for reinvestment purposes.

When all or substanilly all desired identifying data has been received, a security or securities portfolio is thereby created. In addition, it is also understood that multiple portfolios can be utilized by multiple users of the present invention. Also, the security or securities portfolio is capable of being edited at the discretion of the user. The security can include but is not limited to a stock, a preferred stock, a bond, a convertible stock, a convertible bond, an open-ended mutual fund, a closed end mutual fund, a corporate bond, a municipal bond, a government backed mortgage, a collateralized mortgage security, a non-U.S. based security, a U.S. Treasury security, an option or a warrant. In one preferred embodiment, the security is a plurality of securities or a portfolio of securities. In this embodiment, the plurality of securities can include, but is not limited to, any combination of the aforementioned types of securities.

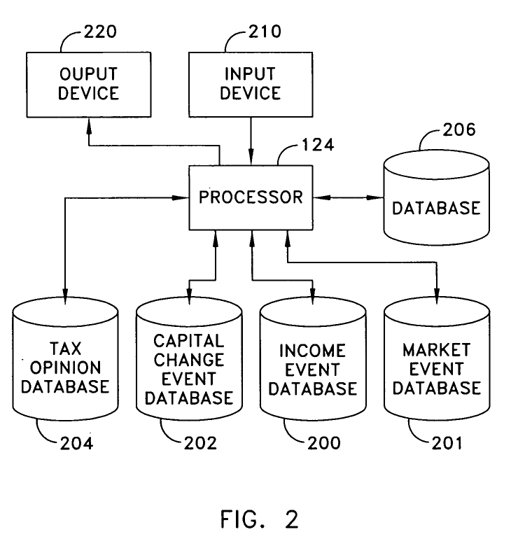

The present invention then correlates a financial event, such as the income event in step 110 or the capital change event in step 112, to the security or securities. The financial event can be one or more income events, capital change events or a combination thereof, that occur within a specified time period. The time period can be inputted by the user as part of the identifying data or can be a default period. Referring to FIG. 2, a processor 124 in communication with one or more databases 200, 201, 202, 204, 206 can be utilized to correlate the financial event to the securities. It is also understood that any combination of such databases can be utilized by a user of the present invention, as well as additional databases not included in FIG. 2. As referenced above, a program or engine is capable of communicating with one or more databases. The program or engine after receiving the relevant data from a database then normalizes such data through data rationalization, which converts the data in useable form by the processor. Alternatively, the data can, in other embodiments, be normalized at the database.

Referring back to FIG. 1, in one preferred embodiment, the current invention correlates an income event to a security and identifying data in step 110. The income event would include, for example, the tax implication of each transaction relating to the security wherein the tax implications would include, but not be limited to, long-term capital gains, short term capital gains, ordinary income, qualified dividends, non-qualified dividends or return of capital, among others, that is associated one or more securities. These tax implication could match the list of securities within the date range.

In the preferred embodiment, the current invention correlates a capital change event to a security and identifying data in step 112. Capital change events includes, but is not limited to, mergers, merger elections, conversions, exchanges, spin-offs, distributions, recapitalizations, liquidations, partial bond calls, stock splits, stock dividends. These events can also include the ratio effect on shares, ratio effect on cost and whether the event is mandatory or voluntary and whether there are multiple optional choices.

In step 113, the effect on cost basis is then determined for one or more securities based on the identifying data in step 112. A cost basis transaction may involve multiple securities and may adjust both cost basis, shares and cash. For example, Company “A” spins off a new Company “B” and pays a cash return. It is a taxable transaction. The original cost basis is divided between “A” and “B” based on valuations set by the company. In addition, both “A” and “B” could have share adjustments. Capital gains may be computed on the new shares and/or the cash return. In step 114, the effect on the number of shares in determined for one or more securities based on the identifying data in step 112. For example, in the event of a capital change event such as a stock split, the shares would be affected depending on if the stock split is a 4-for-1 split, 2-for-1 split or a reverse stock split.

In step 115, the taxation status is then determined. In one embodiment, the current invention provides for retrieving from a database the special taxation status (e.g., “Gain but not Loss”, “Capital Gain Loss-Taxable event”, “Treated as ordinary dividend” or “Nontaxable” among others) matching the capital change and/or income events. The special taxation statuses are consistent with IRS Section 368 rules. In addition, a extensible meta-table of processing instructions which define what effect each event type has on shares, cost, income, cash and tax correlating to the taxation status can be retrieved.

A tax opinion is retrieved in step 120. The tax opinion can be stored and retrieved from the tax opinion database, and can correspond to the capital change events and/or income events. The tax opinion can also have a written portion capable of fully documenting an issuing corporation's legal tax opinion or the opinion of outside counsel to fully document the calculations resulting in the tax consequence. Further, referring to FIG. 2, in one embodiment, the tax opinion database 204 is remotely located from that of the processor 124.

Referring again to FIG. 2, the current invention then provides for access of data from a variety of databases such as a capital change event database 202, a fiscal year date range database (not shown), a market event database 201, an income database 200, security master database (not shown), tax opinion database 204, transaction processing matrix database (not shown), among others.

In one embodiment, the financial event, including capital change event, income event or a combination of both, can be stored on a main database that is in communication with processor 124. One or more of a capital change event, income event, tax opinion and tax status, can be stored on a main database, with the others are stored in one or more separate databases. The separate databases may be remotely located apart from the main database, and can communicate with the processor via a local area network (LAN) or wide area network (WAN) such as the Internet. The system can use the following commercial databases: Xcitek Cost Basis and Capital Changes, Standard & Poors daily dividend service, Standard & Poors CUSIP service, Depository Trust Company dividend & interest, Interactive Data Corp Pricing service. It is understood, however, that other commercial databases can be utilized as desired.

In another embodiment, the income event is stored in the income event database 200, the market or pricing values are stored in a market event database 201, the capital change event stored in the capital change event database 202, and the tax opinion is stored in the tax opinion database 204. Optionally, other data or events that are not stored on these databases 200, 202, 204 can be stored in a fourth database 206. In yet another embodiment, the is the tax opinion is stored in a tax opinion database 204. The tax opinion database 204 is remotely located apart from the fourth database 206 containing the capital change event, income event and tax status. Further, the tax opinion database 204, income event database 200, and capital change events database 202 scan be housed remotely on a commercially available databases.

Referring back to FIG. 1, step 116 involves determining the tax consequences for the portfolio of securities, which includes but is not limited to, long term capital gains, short term capital gains, resulting loss, return of capital, qualified/non-qualified dividend status consistent with IRS code in effect. The tax consequence is based on the financial event (i.e., capital change event, income event or a combination of both) and the identifying data. In one embodiment, determining tax liability of portfolio of investment securities for a given date range, based on the following (but not limited thereto): (i) the list of securities held at the beginning of a predetermined period (this could include, but is not limited to, their CUSIP number, purchase date and shares or face amount and the purchase prices and if dividends are to be reinvested); (ii) the principal trades (i.e. Buys and Sells) executed during with period (inputs can include the shares/face, purchase price and date, among others); (iii) input parameters, including but not limited to, what time period to use and what tax lot method to employ (FIFO, LIFO, AVG, HICOST, LOWCOST).

Using IRS acceptable accounting methods for each beginning position, the current invention can apply applicable transactions in ascending effective date order to each tax lot using rules from a processing meta-table to determine the effect on shares, cost basis, income cash, principal cash and long/short term gain/loss for tax liability purposes. The current invention can thus optimize the tax consequence by allowing calculations to be performed using IRS prescribed tax lot relief methods such as LIFO (Last in first out), FIFO (First in first out), HICOST (High cost lots first), LOWCOST (Low cost lots first) or AVG (Average cost of all lots) and thereby be able to calculate which method best fits the tax payer's situation. Meaning that the order of selecting tax lots to be sold is sorted by the method selected. HIGHCOST for example would sort the list of tax lots by purchase cost, high to low. LOWCOST cost would be the opposite sort. The exception is AVG or average cost. In that case all tax lots are considered together, such that each sell transactions reduces the amount of each tax lot by a prorated amount. That ration being the sell amount divided by the total shares held.

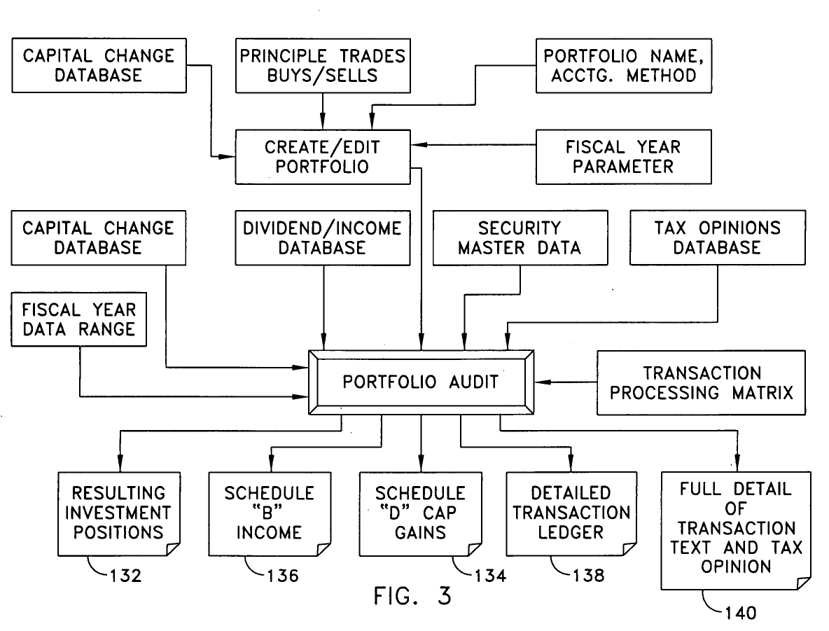

The current invention is capable of presenting for audit purposes a security audit report in step 130, which can provide all supporting documents necessary to prepare a full tax audit and the like. These would include tax opinions of the corporate issuer and tax opinions of outside counsel where appropriate, among others. The current invention provides for full and proper documentation and support for the resultant calculations in the filing of IRS schedules “D” and “B”, such that each transaction or event is completely presented as evidence of proper tax treatment. This would be relevant, for example, in the event of a tax audit or other similar event. FIG. 3 illustrates full and proper documentation and support for the resultant calculations such as presenting, among others, resulting investment positions 132, an IRS Schedule “B” Income form 134, an IRS Schedule “D” Capital Gains form 136, a detailed transaction ledger 138, and full detail of transaction text and tax opinions 140.

Where for each income event in step 110, capital change event in step 112 or a combination of both, a correspond data table of security master information including ticker symbol, CUSIP© symbol or SEDOL© number, issuer description, issue description, country code, currency code and optionally original issue date, original issue price, redemption price to be displayed as part of results to user. For each capital change event matching to special tax status that each tax status be fully explained and documented by referring to tax opinion database and presented as output to user.

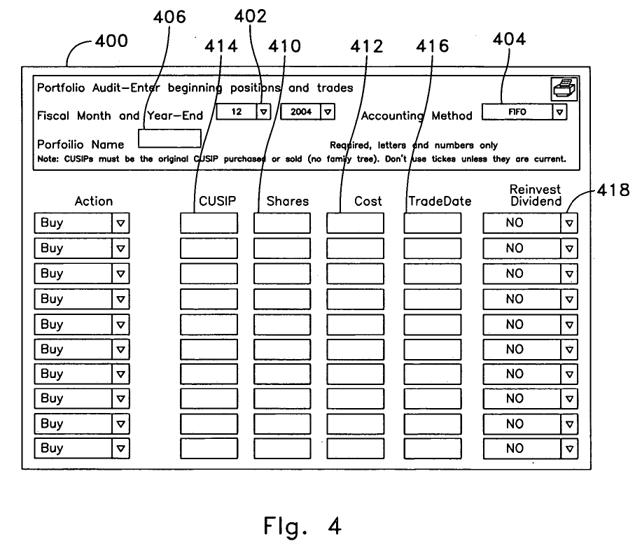

Referring to FIGS. 4-8, the current invention may be displayed in a variety of formats, which can include one or more input screens. As illustrated in FIG. 4, the exemplary input screen 400 can include, but is not limited to, the following: date range 402 for analysis, an accounting method 404, a portfolio of investments (numbered 1 thru n) as held on the beginning date, and principal trades (numbered 1 thru n) or transactions that occurred in the analysis period,. a portfolio name 406, the trade date 416, the number of shares held 410, the cost of the shares 412, and the CUSIP number 414. The user can also be prompted to choose to reinvest the dividends related to the security 418.

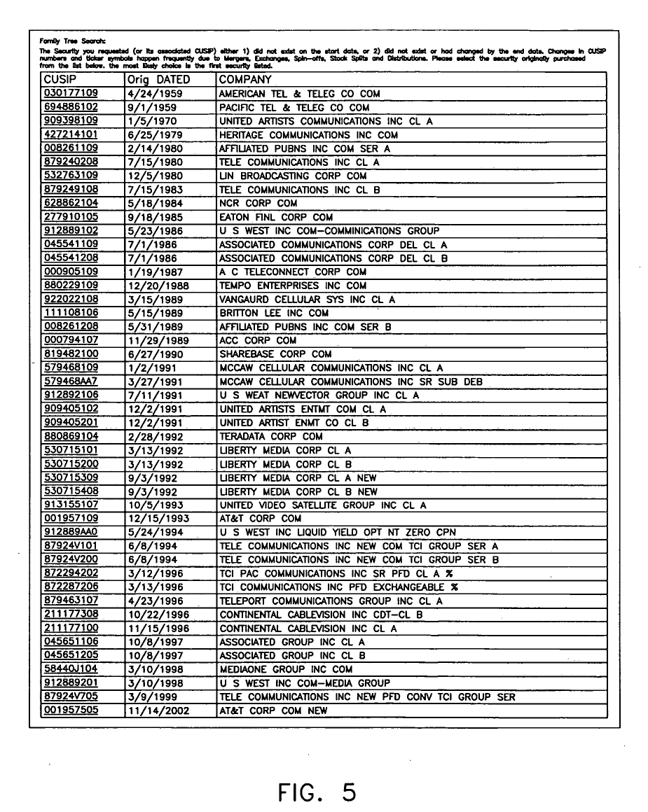

If the company or CUSIP number is not known, in one embodiment of the present invention a database of CUSIP numbers along with their associated entities are displayed to the user. As shown in FIG. 5, in one embodiment a database table is displayed, which can comprises a “family-tree” search for earlier CUSIP numbers and company names that have merged, been exchanged, spun-off or are otherwise different from the current CUSIP or company name. In other words, if the CUSIP entered did not exist on the begin date, then the exemplary database table as illustrated is displayed to the user, the table containing a list of possible starting CUSIPs to be selected that corresponds to the current CUSIPs.

In another embodiment, the present invention provides a reverse calculation function for one or more securities. This function allows a user to determine the financial history of a security including capital change events, income events, prior CUSIP numbers and the like. This allows the user to ascertain the existence of any related securities or additional shares of the security unknown before to the user. Such a function is capable of utilizing the “family-tree” search and database. For example, a user who has just been informed that the user has inherited 100 shares of Stock X and who believes that the shares of Stock X were bought in 1940 can utilize the reverse calculation function. In utilizing the function, the user inputs financial information, such as current CUSIP number, estimated purchase date, and number of shares held. The user can then determine the earlier CUSIP number, prior company name, as well as other relevant financial data of Stock X in 1940. The user can then ascertain the occurrence of any financial events including capital change events and income events from 1940 to the present time. If the prior company spun off a subsidiary, and each owner of one share of Stock X was entitled to receive a half a share of Stock Y, then the user in this example can further investigate whether the user is also entitled to receive 50 shares of Stock Y correlating to the user's 100 shares of Stock X.

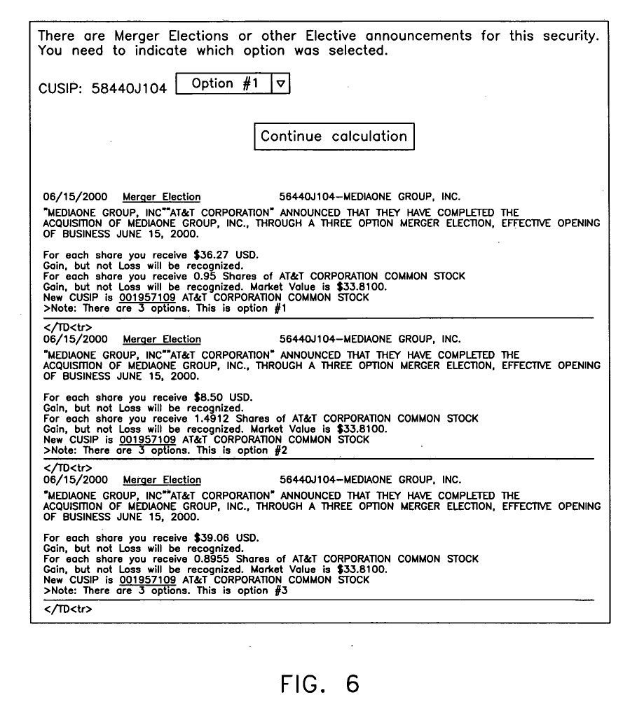

Referring to FIG. 6, if there are such as merger elections, then in an alternative embodiment, the database table display can present the merger election choices for selection by the user. Most corporate actions announced by the corporation are mandatory events. For example stock splits and stock dividends are normally mandatory. There are a number of actions though that are elective. That is, the owner of the security has a choice between multiple options. Sometimes one of the options is to do nothing. This would be the case with a “tender offer” for stock. But others such as Mergers may have elective features. For example Company A is taking over Company B. Owners of Company B stock have the option to receive 2 shares of Company A stock or receive $25.00 per share. These elective options occur more often with mergers and exchanges. The elective options will frequently have different tax treatments for each option. Therefore it is desirable from a tax liability standpoint to understand the implications of each option and to compute the taxes appropriately.

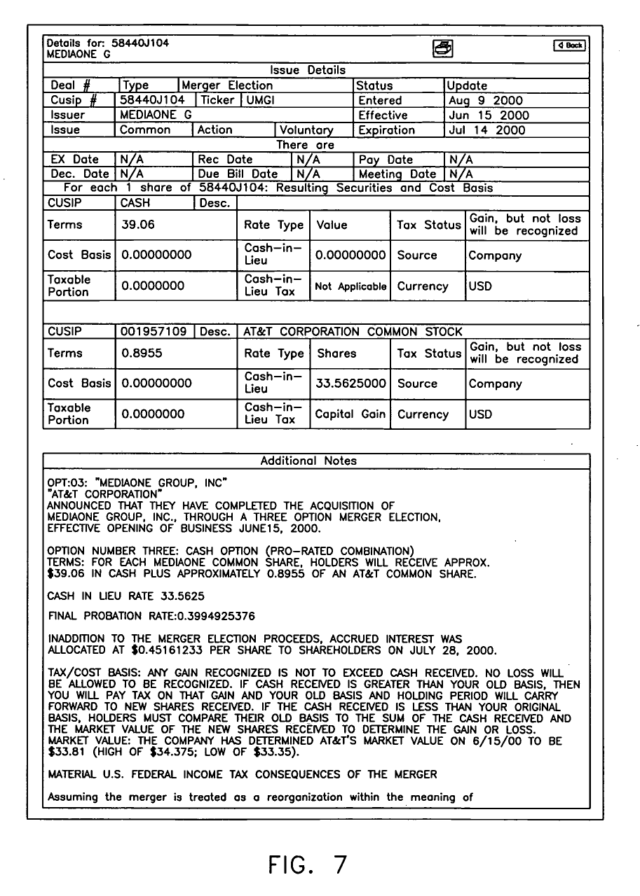

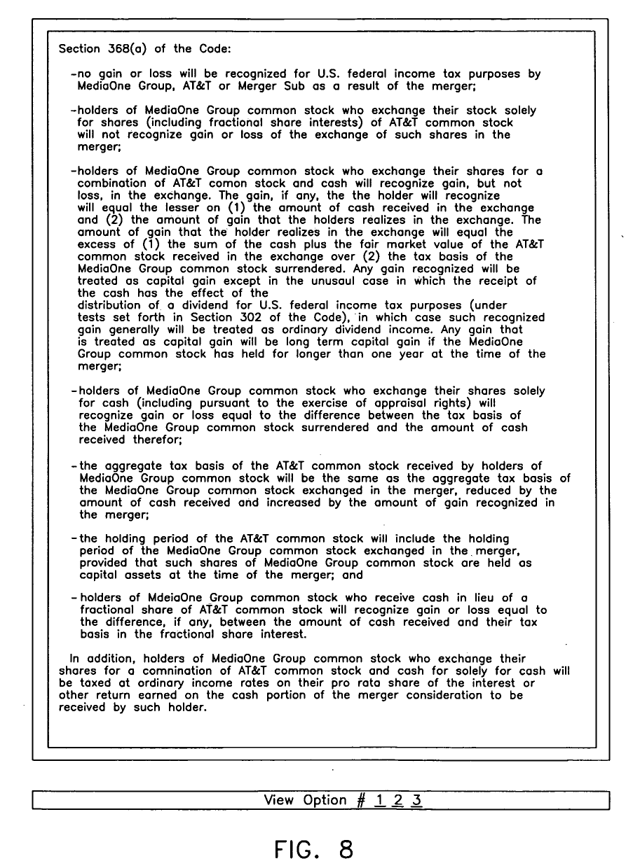

Referring now to FIGS. 7 and 8, portions of a security audit report according to one embodiment of the current invention is illustrated. Such a report can be presented in a variety of way including but not limited to print outs, displays incorporated with a graphical user interfaces and the like. In one embodiment, one or more output screens are displayed. Referring back to FIG. 3, in such an embodiment, the output screens can include but are not limited to the following for each basic screen type: a listing of resulting portfolio positions 132 on the ending date; an IRS-compliant Schedule “D” form 134 comprising capital gains and losses; an IRS-compliant Schedule “B” form 136 comprising earned/paid income consisting of ordinary income, qualified dividends, long/short term capital gains and return of capital; a detailed transaction ledger 138 comprising each transaction and its effect on shares, cost basis, cash, income and tax; and a full text documentation 140 of the transaction text and the tax opinion relating to the transaction. In one preferred embodiment, a hot link to the full text documentation of each transaction, including Special Taxation Status and Issuing company tax opinion of the transaction, can be provided.

Whereas the present invention has been described in relation to the accompanying drawings, it should be understood that other and further modifications, apart from those shown or suggested herein, may be made within the spirit and scope of the present invention. It is also intended that all matter contained in the foregoing description or shown in the accompanying drawings shall be interpreted as illustrative rather than limiting.

What is claimed is:

1. A method of auditing and verifying tax liability of a security and providing a security audit report comprising the steps of:
receiving identifying data for a security, the identifying data comprising a predetermined tax lot method;
correlating a financial event to the security;
determining a share effect based on the financial event and the identifying data;
determining a cost basis effect based on the financial event and the identifying data;
determining a tax consequence based on the financial event and the identifying data;
retrieving a tax opinion corresponding to the tax consequence; and
presenting a security audit report comprising the tax consequence, a transaction ledger, a security financial position and the tax opinion.

2. The method of claim 1 further comprising the step of correlating a taxation status to the financial event, wherein the tax consequence is further based on the taxation status, and wherein the security audit report further comprises the taxation status.

3. The method of claim 2 wherein the security audit report further comprises an IRS Schedule “D” corresponding to the tax consequence and an IRS Schedule “B” corresponding to the tax consequence.

4. The method of claim 1 wherein the identifying data is selected from a group consisting of a security identification number, a transaction type, a transaction date, a beginning date, an ending date, a share position and a share price.

5. The method of claim 1 wherein the security is selected from a group consisting of a stock, a preferred stock, a bond, a convertible stock, an open-ended mutual fund, a closed end mutual fund, a corporate bond, a municipal bond, a government backed mortgage, a collateralized mortgage security, a non-U.S. based security, a U.S. Treasury security, an option and a warrant.

6. The method of claim 1 wherein a plurality of securities is used.

7. The method of claim 6 wherein the plurality of securities is selected from a group consisting of stocks, preferred stocks, convertible stocks, bonds, open-ended mutual funds, closed end mutual funds, corporate bonds, municipal bonds, government backed mortgages, collateralized mortgage securities, non-U.S. based securities, U.S. Treasury securities, options, warrants and any combination thereof.

8. The method of claim 1, wherein the financial event is stored in a financial events database and the tax opinion is stored in a tax opinion database, the tax opinion database being remotely located from the financial events database.

9. The method of claim 2, wherein the financial event is stored in a financial events database and the tax opinion is stored in a tax opinion database, the tax opinion database being remotely located from the financial events database.

10. The method of claim 9 wherein the taxation status is stored within a taxation status database.

11. The method of claim 10 wherein the taxation status database is remotely located from the financial events database.

12. The method of claim 1 wherein the financial event is selected from a group consisting of an income event and a capital change event.

13. The method of claim 12 wherein a plurality of financial events is used.

14. The method of claim 1 wherein the financial event comprises an income event and a capital change event.

15. The method of claim 14 wherein the income event is stored in an income event database and the capital event is stored in a capital event database.

16. The method of claim 15 wherein the capital event is selected from a group consisting of a merger, a conversion, an exchange, a merger election, a spin-off, a distribution, a recapitalization, a liquidation, a partial bond call, a stock split and a stock dividend.

17. The method of claim 1 wherein the tax consequence is selected from a group consisting of an adjusted cost basis of the security, income cash and an adjusted shares position.

18. The method of claim 1 wherein the security audit report further comprises an IRS Schedule “D” corresponding to the corresponding to the tax consequence and an IRS Schedule “B” corresponding to the tax consequence.

19. The method of claim 18 wherein the security audit report is presented through a graphic user interface display.

20. The method of claim 18 wherein the tax opinion is compliant with IRS standards.

21. The method of claim 18 further comprising the step of receiving merger election data, wherein the capital change event is the merger election.

22. The method of claim 1 further comprising the step of receiving instructions to reinvest dividends.

23. A method of auditing and verifying tax liability of a security and providing a security audit report comprising the steps of:
receiving identifying data for a security, the identifying data comprising a predetermined tax lot method;
correlating a capital change event to the security;
correlating a taxation status to the capital change event;
determining a share effect based on the financial event and the identifying data;
determining a cost basis effect based on the financial event and the identifying data;
determining a tax consequence based on the taxation status, the capital change event and the identifying data;
retrieving a tax opinion corresponding to the tax consequence; and
presenting a security audit report comprising the tax consequence, a transaction ledger, a security financial position, the taxation status and the tax opinion.

24. The method of claim 23 further comprising the step of correlating an income event to the security.

25. The method of claim 24 wherein the security audit report further comprises an IRS Schedule “D” corresponding to the corresponding to the tax consequence and an IRS Schedule “B” corresponding to the tax consequence.

26. The method of claim 25 wherein the income event is stored in an income event database, the capital change event is stored in a capital change event database and the tax opinion is stored in a tax opinion database, the tax opinion database being remotely located from at least one of the capital change event database and the financial event database.

27. The method of claim 26 wherein the taxation status is stored in a taxation status database.

28. The method of claim 23 wherein the capital event is selected from a group consisting of a merger, a conversion, an exchange, a merger election, a spin-off, a distribution, a recapitalization, a liquidation, a partial bond call, a stock split and a stock dividend.

29. The method of claim 23 wherein the identifying data is selected from a group consisting of a security identification number, a transaction type, a transaction date, a beginning date, an ending date, a share position and a share price.

30. The method of claim 23 wherein a plurality of securities is used.

31. The method of claim 30 wherein the plurality of securities is selected from a group consisting of stocks, preferred stocks, convertible stocks, bonds, open-ended mutual funds, closed end mutual funds, corporate bonds, municipal bonds, government backed mortgages, collateralized mortgage securities, non-U.S. based securities, U.S. Treasury securities, options, warrants and any combination thereof.

32. The method of claim 23 further comprising the step of receiving merger election data, wherein the capital change event is the merger election.

33. A system for auditing and verifying the tax liability of a security and providing a security audit report comprising:
a first database containing first data comprising at least one selected from the group consisting of an income event corresponding to the security, a capital change event corresponding to the security, and a taxation status corresponding to the security;
a processor capable of receiving identifying data for a security, wherein the processor is capable of determining a tax consequence based on the first data;
a second database containing a tax opinion; and
a device capable of presenting a security audit report comprising the tax consequence, a transaction ledger based the first data, a security financial position and the tax opinion.

34. The system of claim 33 wherein the security audit further comprises an IRS Schedule “D” corresponding to the corresponding to the tax consequence and an IRS Schedule “B” corresponding to the tax consequence.

35. The system of claim 33 wherein the first database comprises an income event database containing an income event corresponding to the security and a capital change event database containing a capital change event corresponding to the security.

36. The system of claim 35 wherein the first database further comprises a tax database containing a taxation status corresponding to the security.

37. The system of claim 33 wherein the second database is remotely located from the first database.

38. A method of determining the financial history of a security comprising the steps of:
receiving identification data for a security, the identifying data comprising at least an estimated security purchase date;
retrieving at least one prior CUSIP number or at least one company name based on the identifying data;
correlating, beginning from the estimated security purchase date, at least one financial event to the prior CUSIP number or the company name; and
determining a number of shares or a related security based on the financial event.
